(19) United States
(12) Patent Application Publication
(10) Pub. No.: US 2024/0249643 A1
(43) Pub. Date: Jul. 25, 2024

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Shuji MIYAI, Toyota-shi (JP); Yasuyuki KAMEZAKI, Toyota-shi (JP); Masato ENDO, Nagoya-shi (JP); Seira NAKATA, Tokyo (JP)

(73) Assignee: TOYOTA JIDOSHA KABUSHIKI KAISHA, Toyota-shi (JP)

(21) Appl. No.: 18/509,606

(22) Filed: Nov. 15, 2023

(30) Foreign Application Priority Data
Jan. 25, 2023 (JP) 2023-009482

(51) Int. Cl. G09B 19/16

(52) U.S. Cl. CPC G09B 19/167

(57) ABSTRACT

An information processing apparatus includes a control unit. The control unit is configured to execute: a process of presenting a user a plurality of missions respectively corresponding to a plurality of items of driving assessment; a process of setting one or more first missions for the user, the one or more first missions being selected by the user from among the plurality of missions; a process of determining whether the user has cleared the one or more first missions based on the driving assessment corresponding to the one or more first missions; and a process of presenting the user the plurality of missions including a second mission higher in difficulty level than the one or more first missions in response to a situation that the user has cleared the one or more first missions.

### CROSS-REFERENCE TO RELATED APPLICATION

This application claims priority to Japanese Patent Application No. 2023-009482 filed on Jan. 25, 2023, incorporated herein by reference in its entirety.

### BACKGROUND

### 1. Technical Field

The disclosure relates to an information processing apparatus and an information processing method.

### 2. Description of Related Art

It is known that a physical quantity that changes based on at least one of traveling, steering, and braking of a vehicle or a physical quantity that changes as a result of operation of a predetermined operating member is detected and then the score of driving operation is computed based on the detected value (see, for example, Japanese Unexamined Patent Application Publication No. 2022-138727 (JP 2022-138727 A)).

### SUMMARY

The disclosure facilitates user safe driving.

A first aspect of the disclosure provides an information processing apparatus. The information processing apparatus includes a control unit. The control unit is configured to execute: a process of presenting a user a plurality of missions respectively corresponding to a plurality of items of driving assessment; a process of setting one or more first missions for the user, the one or more first missions being selected by the user from among the plurality of missions; a process of determining whether the user has cleared the one or more first missions based on the driving assessment corresponding to the first missions; and a process of presenting the user the plurality of missions including a second mission higher in difficulty level than the one or more first missions in response to a situation that the user has cleared the one or more first missions.

In the above aspects, the control unit may be configured to execute a process of determining whether the user has cleared the one or more first missions at intervals of a predetermined travel distance.

In the above aspects, the control unit may be configured to execute a process of setting a rank of the user according to the number of the one or more first missions cleared by the user and presenting the user the rank.

In the above aspects, the control unit may be configured to execute a process of setting a plurality of the first missions for the user in response to a situation that the user has selected the plurality of the first missions.

In the above aspects, the control unit may be configured to execute a process of setting the first mission for the user for each of the plurality of items of driving assessment.

In the above aspects, the control unit may be configured to execute a process of setting an upper limit to the number of the first missions set.

In the above aspects, the control unit may be configured to execute a process of setting limitations on a combination of the plurality of the first missions.

In the above aspects, the control unit may be configured to execute a process of, when the plurality of the first missions is classified into a plurality of categories, setting an upper limit to the number of the first missions corresponding to each of the categories.

In the above aspects, the control unit may be configured to execute a process of, only when all the first missions of the same level among the plurality of missions respectively corresponding to the plurality of items of driving assessment have been cleared, presenting the user the second mission.

In the above aspects, the control unit may be configured to execute a process of notifying the user that the one or more first missions have been cleared in response to a situation that the user has cleared the one or more first missions.

In the above aspects, the control unit may be configured to execute a process of showing the one or more first missions underway by the user on an initial screen of a user interface presenting the plurality of missions.

In the above aspects, the control unit may be configured to execute a process of generating information on an incentive according to a situation that the user has cleared the one or more first missions, and a process of putting a cap on the incentive for every predetermined period.

In the above aspects, the control unit may be configured to execute a process of, when a plurality of the first missions has been cleared at the same time, giving the incentive larger in amount than when one of the one or more first missions has been cleared.

A second aspect of the disclosure provides an information processing method executed by a computer. The information processing method includes: presenting a user a plurality of missions respectively corresponding to a plurality of items of driving assessment; setting one or more first missions for the user, the one or more first missions being selected by the user from among the plurality of missions; determining whether the user has cleared the one or more first missions based on the driving assessment corresponding to the one or more first missions; and presenting the user the plurality of missions including a second mission higher in difficulty level than the one or more first missions in response to a situation that the user has cleared the one or more first missions.

In the above aspects, the information processing method may further include determining whether the user has cleared the one or more first missions at intervals of a predetermined travel distance.

In the above aspects, the information processing method may further include setting a rank of the user according to the number of the one or more first missions cleared by the user and presenting the user the rank.

In the above aspects, the information processing method may further include setting a plurality of the first missions for the user in response to a situation that the user has selected the plurality of the first missions.

In the above aspects, the information processing method may further include, only when all the first missions of the same level among the plurality of missions respectively corresponding to the plurality of items of driving assessment have been cleared, presenting the user the second mission.

In the above aspects, the information processing method may further include notifying the user that the one or more first missions have been cleared in response to a situation that the user has cleared the one or more first missions.

In the above aspects, the information processing method may further include generating information on an incentive according to a situation that the user has cleared the one or more first missions, and putting a cap on the incentive for every predetermined period.

Another aspect of the disclosure provides a program for causing a computer to execute the information processing method or a non-transitory storage medium storing the program.

According to the aspects of the disclosure, it is possible to facilitate user safe driving.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram that shows the schematic configuration of a system according to a first embodiment;

FIG. 2 is a block diagram that schematically shows an example of the configuration of each of a vehicle, a user terminal, and a server that make up the system according to the first embodiment;

FIG. 3 is a block diagram that illustrates the functional configuration of the server according to the first embodiment;

FIG. 4 is a view that illustrates a table configuration of a vehicle information DB according to the first embodiment;

FIG. 5 is a view that illustrates a table configuration of a detection information DB according to the first embodiment;

FIG. 6 is a table that shows criteria to clear, respectively corresponding to levels of items;

FIG. 7 is a view that illustrates a table configuration of a level information DB according to the first embodiment;

FIG. 8 is a view that shows an example of an initial screen that appears as a result of launching an application in the user terminal;

FIG. 9 is a view that shows an example of a select screen;

FIG. 10 is a view that shows a change window;

FIG. 11 is a view that shows an example of an initial screen indicating that Level 4 of sudden acceleration is underway;

FIG. 12 is a diagram that shows an example of a functional component element of an ECU according to the first embodiment;

FIG. 13 is a diagram that shows the functional configuration of the user terminal according to the first embodiment;

FIG. 14 is a flowchart of a process of managing missions in the server according to the first embodiment;

FIG. 15 is a flowchart of a process of presenting missions in the server according to the first embodiment;

FIG. 16 is a view that illustrates a table configuration of a level information DB according to a second embodiment;

FIG. 17 is a flowchart of a process of managing missions in the server according to the second embodiment; and

FIG. 18 is a flowchart of a process of giving an incentive in the server according to a third embodiment.

### DETAILED DESCRIPTION OF EMBODIMENTS

Most of existing driving assessment systems issue an assessment report every trip. However, when there are no characteristic driving behaviors, similar assessment reports are issued, so there are no special interests for users. If such assessment reports are successively issued, users get bored and sooner or later stop reading assessment reports.

An information processing apparatus that is one of the aspects of the disclosure includes a control unit. The control unit is configured to execute: a process of presenting a user a plurality of missions respectively corresponding to a plurality of items of driving assessment; a process of setting one or more first missions for the user, the one or more first missions being selected by the user from among the plurality of missions; a process of determining whether the user has cleared the one or more first missions based on the driving assessment corresponding to the one or more first missions; and a process of presenting the user the plurality of missions including a second mission higher in difficulty level than the one or more first missions in response to a situation that the user has cleared the one or more first missions.

Examples of the plurality of items of driving assessment include sudden steering, sudden braking, sudden acceleration, overspeed, and activating a direction indicator in a short time. Examples of the items of driving assessment may also include items on improvement in fuel efficiency or the like. For example, items that can improve fuel efficiency, such as moderate start, moderate acceleration, traveling with a constant accelerator operation amount, use of regenerative brake, and stop-start function may be subjected to driving assessment. Examples of the items of driving assessment may also include items on improvement in driving technique or the like. For example, items, such as slowly starting to turn and return during steering operation and moderate cornering, may be subjected to driving assessment. A driving assessment may be, for example, made based on output values of sensors attached to a vehicle.

A plurality of missions is presented to a user in correspondence with a plurality of items of driving assessment. The missions each set according to an item of driving assessment. When, for example, the item of driving assessment is sudden deceleration (which may be sudden braking), not detecting sudden deceleration in a predetermined distance is presented to a user as a mission. When the user selects the mission, the mission is set as a first mission. The control unit determines whether the user has cleared the first mission based on driving assessment. When the first mission has been cleared, a second mission higher in difficulty level than the first mission is presented to the user. The second mission may be a mission of which a threshold is changed in a direction in which the difficulty level increases as compared to the first mission. The control unit presents not only the second mission but also missions corresponding to other items to the user. Therefore, after the user clears the first mission, the user does not need to immediately select the second mission and is able to select a mission lower in difficulty level and corresponding to another item.

In this way, if the user is able to try a mission as if playing a game, it can be a chance for the user to perform safe driving. The user is able to obtain a sense of accomplishment by clearing a mission. Therefore, it is possible to suppress a situation in which the user gets bored with application software (hereinafter, also referred to as application) that provides driving assessment.

The control unit may determine whether the user has cleared the first mission at intervals of a predetermined travel distance. When a mission is terminated at intervals of a predetermined travel distance, the timing at which a mission ends becomes clear. Thus, it is possible to orient the awareness of the user toward a mission. It is possible to adjust the difficulty level of a mission by adjusting a predetermined distance.

The control unit may set a rank of the user according to the number of the first missions cleared by the user and present the rank to the user. When the rank is presented, it is possible to further increase motivation of the user to clear a mission.

The control unit may set a plurality of the first missions for the user in response to a situation that the user has selected a plurality of the first missions. When a plurality of the first missions is set at the same time, the user keeps in mind to perform driving corresponding to the plurality of items of driving assessment. As a result, it is possible to facilitate safe driving.

The control unit may set the first mission for the user for each of the plurality of items of driving assessment. As a result, the user is able to challenge a plurality of missions at the same time. When the first mission is set for each item of driving assessment, it is possible to suppress a situation in which the first missions become missions with overlapping details.

The control unit may set an upper limit to the number of the first missions set. As a result, the user is able to challenge a longer-term mission, so the user tries to perform safe driving for a longer period.

The control unit may set limitations on a combination of a plurality of the first missions. When, for example, first missions with similar details are combined and set, a possibility that the first missions can be cleared at the same time increases. As a result, missions that can be presented to the user run out soon. In contrast, when limitations are set on a combination of first missions, the user is able to challenge a mission for a longer period.

When the plurality of first missions is classified into a plurality of categories, the control unit may set an upper limit to the number of the first missions corresponding to each of the categories. Examples of the categories include a category of safe driving, a category of ecology, and a category of improvement in driving technique. When, for example, an upper limit is set on the number of missions selectable in each category, it is possible to challenge a mission for a longer period for a plurality of categories, so it is possible to suppress a situation in which the user gets bored.

Only when all the first missions of the same level among a plurality of missions respectively corresponding to the plurality of items of driving assessment have been cleared, the control unit may present the user the second mission. Even when, for example, the levels of items the user is good at increase, the driving technique of the user is not regarded as being sufficiently raised. It is possible to further improve the driving technique of the user by uniformly increasing the levels of the other items.

The control unit may notify the user that the first mission has been cleared in response to a situation that the user has cleared the first mission. Examples of the notification include push notification sent to the terminal of the user, notification by e-mail, and notification by SMS. When the user is notified that a mission has been cleared, the user is able to select a new mission, so it is possible to orient the awareness of the user to the mission.

The control unit may show the first mission underway by the user on an initial screen of a user interface presenting the plurality of missions. Since the user is able to check the mission underway by the user only by viewing the initial screen of the user interface, it is possible to improve user convenience.

The control unit may generate information on an incentive according to a situation that the user has cleared the first mission and put a cap on the incentive for every predetermined period. When an incentive is given, it is possible to increase motivation of the user to challenge a mission. On the other hand, there can be a case where funds of incentives are limited, so, when a cap is put for every predetermined period, it is possible to suppress early using up of the funds. Therefore, the user is able to receive an incentive for a longer period.

When a plurality of the first missions has been cleared at the same time, the control unit may give the incentive larger in amount than when one of the first missions has been cleared. When a plurality of the first missions has been cleared at the same time, a larger amount of incentive is given as a bonus to make it possible to increase motivation to clear a mission.

Hereinafter, embodiments of the disclosure will be described with reference to the accompanying drawings. The configurations of the following embodiments are illustrative, and the disclosure is not limited to the configurations of the embodiments. The following embodiments may be combined as long as possible.

### First Embodiment

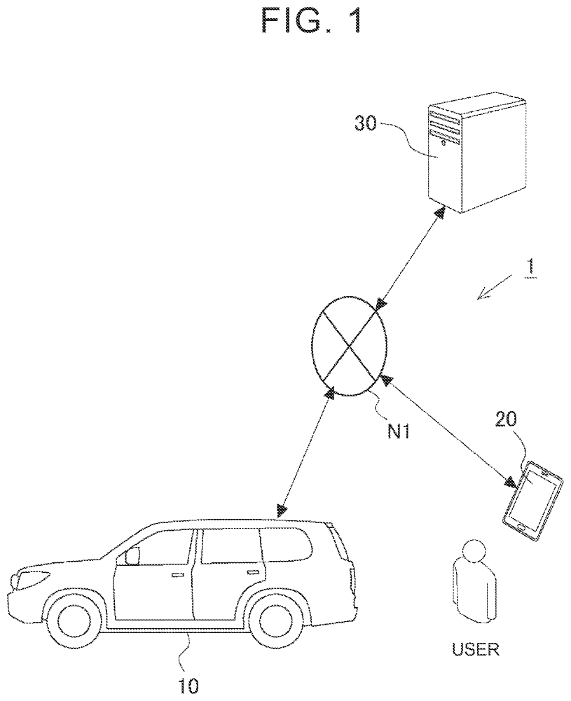

FIG. 1 is a diagram that shows the schematic configuration of a system 1 according to a first embodiment. The system 1 is a system in which a server 30 makes a driving assessment based on information on travel of a vehicle 10 and presents missions to a user.

In the example of FIG. 1, the system 1 includes the vehicle 10, a user terminal 20, and the server 30. The user terminal 20 is a mobile terminal carried by the user. The user terminal 20 is registered in the server 30 in association with the vehicle 10. The user is able to try a mission by using the user terminal 20.

The vehicle 10, the user terminal 20, and the server 30 are connected to one another by a network N1. The network N1 is, for example, a world wide public telecommunication network, such as the Internet. A wide area network (WAN) or another communication network may be adopted as the network N1. The network N1 may include a telephone communication network for mobile phones or the like and/or a wireless communication network, such as Wi-Fi (registered trademark). The vehicle 10 may be connected to the user terminal 20 via near field communication. FIG. 1 illustratively shows one vehicle 10; however, there can be a plurality of the vehicles 10. The number of the users and the number of the user terminals 20 can be multiple according to the number of the vehicles 10.

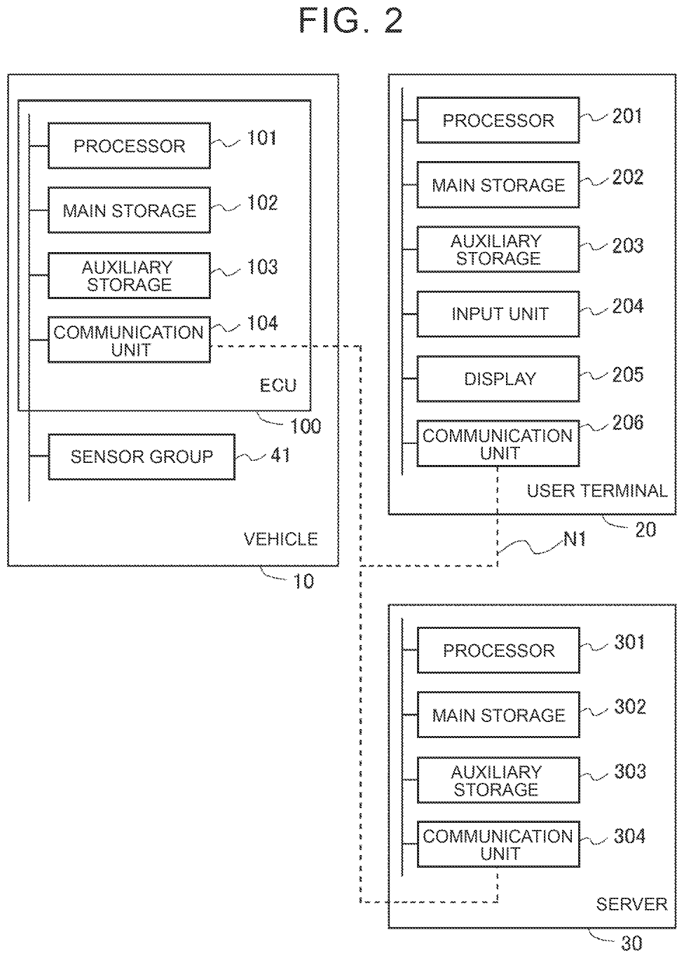

The hardware configuration of each of the vehicle 10, the user terminal 20, and the server 30 will be described with reference to FIG. 2. FIG. 2 is a block diagram that schematically shows an example of the configuration of each of the vehicle 10, the user terminal 20, and the server 30 that make up the system 1 according to the first embodiment.

The server 30 includes components of a computer. The server 30 includes a processor 301, a main storage 302, an auxiliary storage 303, and a communication unit 304. These are connected to one another by a bus. The processor 301 is an example of the control unit.

The processor 301 is a central processing unit (CPU), a digital signal processor (DSP), or the like. The processor 301 controls the server 30 and operates various pieces of information processing. The main storage 302 is a random access memory (RAM), a read only memory (ROM), or the like. The auxiliary storage 303 is an erasable programmable ROM (EPROM), a hard disk drive (HDD), a removable medium, or the like. An operating system (OS), various programs, various tables, and the like are stored in the auxiliary storage 303. The processor 301 loads a program stored in the auxiliary storage 303 onto a work area of the main storage 302 and runs the program. Constituent components and the like are controlled as a result of running the program. Thus, a function that matches a predetermined purpose is implemented by the server 30. The main storage 302 and the auxiliary storage 303 are computer-readable recording media. The server 30 may be a single computer or may be a plurality of computers that cooperate with one another. Information stored in the auxiliary storage 303 may be stored in the main storage 302. Information stored in the main storage 302 may be stored in the auxiliary storage 303.

The communication unit 304 is a device that communicates with the vehicle 10 and the user terminal 20 through the network N1. The communication unit 304 is, for example, a local area network (LAN) interface board or a wireless communication circuit for wireless communication. The LAN interface board and the wireless communication circuit are connected to the network N1.

A series of processes that are executed by the server 30 can be executed by hardware and can also be executed by software.

Next, the user terminal 20 will be described. The user terminal 20 is, for example, a small computer, such as a smartphone, a mobile phone, a tablet terminal, a personal information terminal, a wearable computer (such as a smart watch), and a personal computer (PC). The user terminal 20 includes a processor 201, a main storage 202, an auxiliary storage 203, an input unit 204, a display 205, and a communication unit 206. These are connected to one another by a bus. The processor 201, the main storage 202, and the auxiliary storage 203 are similar to the processor 301, the main storage 302, and the auxiliary storage 303 of the server 30, so the description thereof is omitted.

The input unit 204 is a device to receive an input operation performed by the user and is, for example, a touch panel, a mouse, a keyboard, a microphone, a push button, or the like. The display 205 is a device that presents information to the user and is, for example, a liquid crystal display (LCD), an electroluminescence (EL) panel, or the like. The input unit 204 and the display 205 may be configured as one touch panel display.

The communication unit 206 is a communication device for connecting the user terminal 20 with the network N1. The communication unit 206 is, for example, a circuit for communicating with another device (for example, the vehicle 10, the server 30, or the like) via the network N1 by using a mobile communication service (for example, a telephone communication network, such as 6th generation (6G), 5th generation (5G), 4th generation (4G), 3rd generation (3G), and long term evolution (LTE)), or a wireless communication network, such as Wi-Fi (registered trademark) and Bluetooth (registered trademark).

Next, the vehicle 10 will be described. The vehicle 10 includes an ECU 100 that is an electronic control unit, and a sensor group 41. These component elements are connected to one another by a CAN bus that is a bus of an in-vehicle network. These component elements each do not need to be a single module and may be implemented by a combination of in-vehicle devices, such as a car navigation system, onboard communication instruments, or the like.

The ECU 100 includes components of a computer. The ECU 100 includes a processor 101, a main storage 102, an auxiliary storage 103, and a communication unit 104. These are connected to one another by a bus. The processor 101, the main storage 102, the auxiliary storage 103, and the communication unit 104 are similar to the processor 201, the main storage 202, the auxiliary storage 203, and the communication unit 206 of the user terminal 20, so the description thereof is omitted.

The sensor group 41 includes, for example, sensors that detect the status of the vehicle 10, sensors that detect the operations of a driver, and the like. The sensor group 41 includes, for example, a speed sensor, an acceleration sensor, an accelerator operation amount sensor, a steering angle sensor, a yaw rate sensor, a turn signal switch sensor (a sensor that detects the status of a switch for a direction indicator), a shift position sensor, a location information sensor (GPS sensor), a brake switch, or the like. The sensor group 41 may include a sensor that detects activation of a system, such as precrash safety or the like.

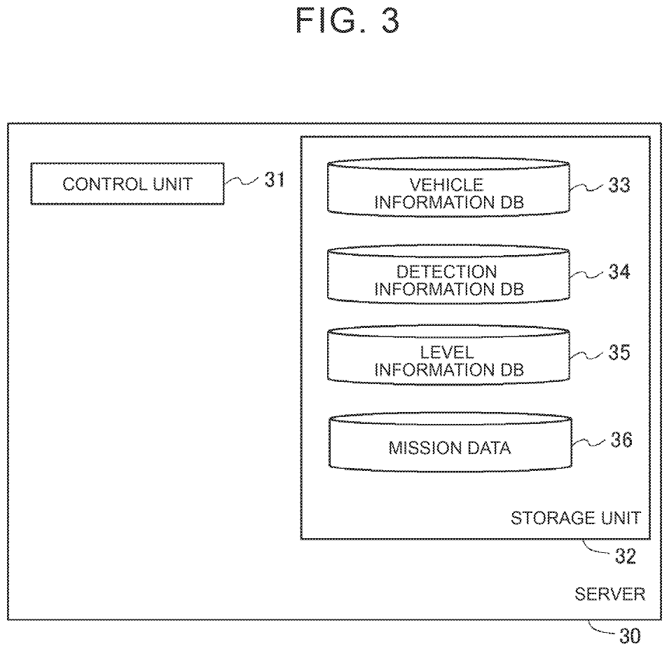

Next, the functions of the server 30 will be described. FIG. 3 is a block diagram that illustrates the functional configuration of the server 30 according to the first embodiment. The server 30 includes a control unit 31 and a storage unit 32 as functional component elements. The processor 301 of the server 30 executes a process of the control unit 31 in accordance with a computer program on the main storage 302. The storage unit 32 is configured to include the main storage 302 and the auxiliary storage 303. The storage unit 32 stores a vehicle information DB 33, a detection information DB 34, a level information DB 35, and mission data 36. The vehicle information DB 33, the detection information DB 34, and the level information DB 35 are, for example, relational databases.

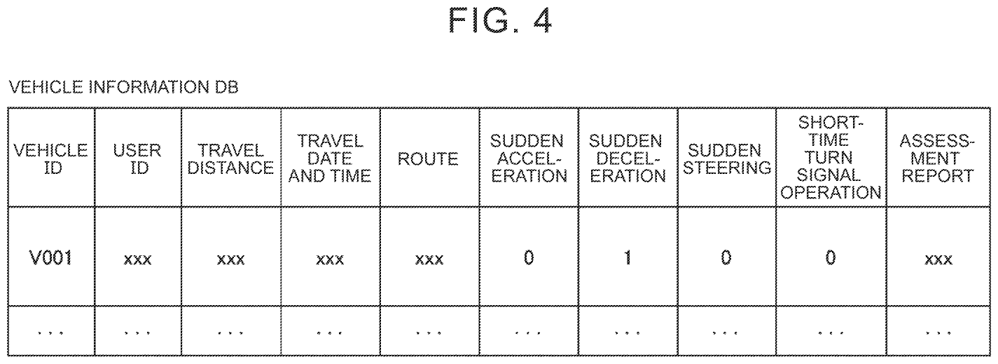

When the control unit 31 receives travel information from the vehicle 10, the control unit 31 updates the vehicle information DB 33 and the detection information DB 34. Travel information is information related to travel of the vehicle 10 and is information including detected values of the sensor group 41, a travel distance of the vehicle 10, a travel date and time of the vehicle 10, a route of the vehicle 10, and a vehicle ID. FIG. 4 is a view that illustrates a table configuration of the vehicle information DB 33 according to the first embodiment. The vehicle information DB 33 has fields of vehicle ID, user ID, travel distance, travel date and time, route, sudden acceleration, sudden deceleration, sudden steering, short-time turn signal operation, and assessment report. Each record of the vehicle information DB 33 is generated every one trip. Travel information, for example, may be sent from the vehicle 10 to the server 30 every one trip or may be sent from the vehicle 10 to the server 30 at intervals of a predetermined period of time.

Information with which the vehicle 10 can be identified (vehicle ID) is stored in the vehicle ID field. Information with which the user associated with the vehicle 10 can be identified (user ID) is stored in the user ID field. The vehicle 10 and the user terminal 20 are associated with the user ID. Information on a total travel distance of the vehicle 10 at a point in time a trip starts is stored in the travel distance field. Information on a date and time at which the vehicle 10 has travelled is stored in the travel date and time field. A date and time at which the vehicle 10 has travelled may include information on a date and time at which the vehicle 10 starts up, a date and time at which the vehicle 10 shuts down, or both of them. Information on the number of times the vehicle 10 has made sudden acceleration is stored in the sudden acceleration field. Sudden acceleration means that, for example, the speed of the vehicle 10 increases by 6 km/h or more in 0.5 seconds. Therefore, the control unit 31 is capable of detecting sudden acceleration based on the speed of the vehicle 10. When the control unit 31 detects sudden acceleration, the control unit 31 adds one to the value of the sudden acceleration field.

Information on the number of times the vehicle 10 has made sudden deceleration is stored in the sudden deceleration field. Sudden deceleration means that, for example, the speed of the vehicle 10 decreases by 7 km/h or more in 0.5 seconds. Therefore, the control unit 31 is capable of detecting sudden deceleration based on the speed of the vehicle 10. When the control unit 31 detects sudden deceleration, the control unit 31 adds one to the value of the sudden deceleration field.

Information on the number of times the vehicle 10 has made sudden steering is stored in the sudden steering field. Sudden steering means that, for example, the angular acceleration of a steering angle becomes greater than or equal to a threshold. Therefore, the control unit 31 is capable of determining whether sudden steering has been made based on the steering angle of the vehicle 10. When the control unit 31 detects that sudden steering has been made, the control unit 31 adds one to the value of the sudden steering field.

Information on the number of times a short-time turn signal operation has been made is stored in the short-time turn signal operation field. Short-time turn signal operation means that a period of time to blink a direction indicator is shorter than an adequate period of time. The control unit 31 determines that a short-time turn signal operation has been made when, for example, a period of time during which a turn signal switch is on is shorter than or equal to 2.0 seconds. When the control unit 31 detects a short-time turn signal operation, the control unit 31 adds one to the value of the short-time turn signal operation field.

Information on an assessment report that is a report on the results of driving assessment is input to the assessment report field. For example, information on a place where an assessment report is stored is input to the assessment report field. An assessment report is generated by the control unit 31. The control unit 31 generates an assessment report every one trip. An assessment report, for example, presents the user that a predetermined behavior (sudden acceleration, sudden deceleration, sudden steering, and short-time turn signal operation) has been made and an advice, a message, or the like about driving. An assessment report is stored in the auxiliary storage 303, and the user is able to read the assessment report by accessing from the user terminal 20. When the control unit 31 generates an assessment report, the control unit 31 notifies the user terminal 20 that the assessment report is generated.

Information stored in the vehicle information DB 33 is not limited to the above-described pieces of information as long as information is necessary to make a driving assessment. For example, a case where the vehicle 10 has travelled on a road at a speed higher by a predetermined value or more than a speed limit set for the road, a case where the vehicle 10 has not stopped for a predetermined period of time before the vehicle 10 is reversed, a case where automatic brake based on precrash safety is activated, or a case where the vehicle 10 is reversed at a predetermined speed or higher may be stored in the vehicle information DB 33 as an item used when a driving assessment is made. Only part of the above-described pieces of information may be used.

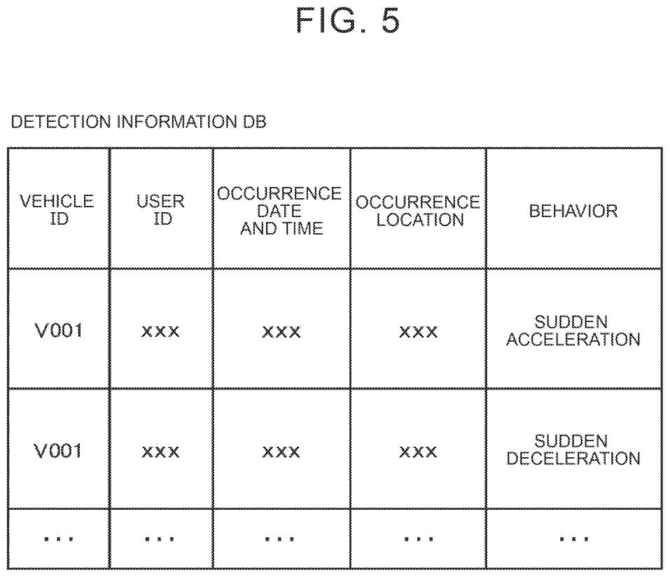

When the control unit 31 detects a predetermined behavior, the control unit 31 updates the detection information DB 34. FIG. 5 is a view that illustrates a table configuration of the detection information DB 34 according to the first embodiment. The detection information DB 34 has fields of vehicle ID, user ID, occurrence date and time, occurrence location, and behavior. Each record of the detection information DB 34 is generated each time a predetermined behavior is detected. The vehicle ID field and the user ID field are associated with those of the vehicle information DB 33. Information on a date and time at which a predetermined behavior has occurred is input to the occurrence date and time field. Information on a location where a predetermined behavior has occurred is input to the occurrence location field. This location is a location in a route stored in the vehicle information DB 33. Information on a behavior detected is input to the behavior field. Any one of sudden acceleration, sudden deceleration, sudden steering, and short-time turn signal operation, described for the vehicle information DB 33, is input to the behavior field.

The control unit 31 presents a mission to the user. The mission is, for example, presented as a mission to fulfill by the user. The mission may be provided as a game that comes with driving assessment. The control unit 31 presents a target for each item corresponding to a predetermined behavior and, when the user clears the target, the control unit 31 shows the next mission higher in difficulty level. For example, missions in five levels, that is, Level 1 to Level 5, are presented for each item. Here, Level 1 is the easiest mission, and the difficulty level increases as the level rises. Level 1 is, for example, a mission with a difficulty level that 80% of people can clear even when people are not aware of the mission or a mission with a difficulty level that anyone can clear when people are aware of the mission. Level 2 is, for example, a mission with a difficulty level that 50% of people can clear even when people are not aware of the mission or a mission with a difficulty level that 80% of people can clear when people are aware of the mission. Level 3 is, for example, a mission with a difficulty level that 25% of people can clear even when people are not aware of the mission or a mission with a difficulty level that 50% of people can clear when people are aware of the mission. Missions of Level 1 to Level 3 are set to difficulty levels so that the missions can be relatively easily cleared. Thus, it is possible to give a sense of accomplishment to the user.

Level 4 is not allowed to be selected unless, for example, all the Level 3 missions of the other items are cleared. Level 4 is also set as a mission with a difficulty level that cannot be easily cleared unless people are aware of the mission. Level 5 provides a worthwhile mission with a further higher difficulty level for the user. Thus, it is possible for the user to keep in mind safe driving awareness.

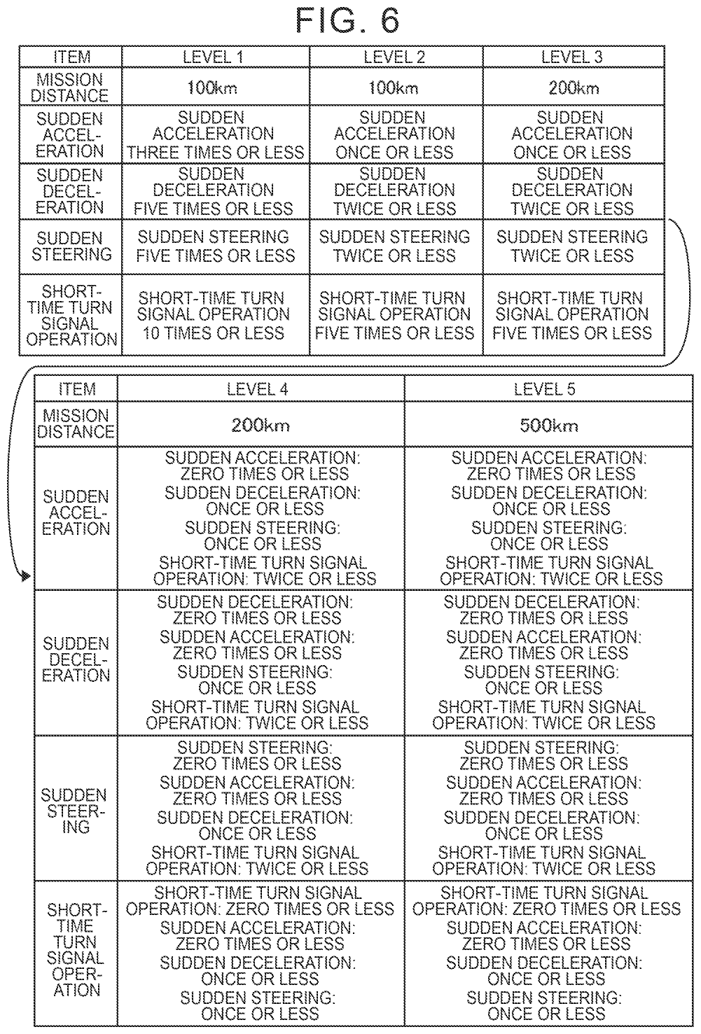

Here, FIG. 6 is a table that shows criteria to clear, respectively corresponding to levels of items. Criteria to clear are respectively shown by thresholds of the numbers of times the items are detected. The relationship is stored in the storage unit 32 as the mission data 36. In FIG. 6, a mission distance is a distance that the vehicle has to travel before a mission is complete. For example, to clear a mission of Level 1 for sudden acceleration, the number of times sudden acceleration is detected during times when the vehicle travels 100 km has to be less than or equal to three. When Level 1 and Level 2 are compared in each item, the mission distance is the same, but the threshold of the number of times each item is detected is reduced. Therefore, Level 2 is higher in difficulty level than Level 1. The user is able to select a mission in each item, but the user needs to clear missions in order from Level 1 in each item.

When Level 2 and Level 3 are compared in each item, the threshold of the number of times each item is detected is the same, but the mission distance is extended. Therefore, Level 3 is higher in difficulty level than Level 2. At Level 4, conditions for clearing a mission of each item include the numbers of times other items are detected. For example, to clear a mission of Level 4 for sudden acceleration, in addition to the condition that the number of times sudden acceleration is detected during times when the vehicle travels 200 km is less than or equal to zero, all of the condition that the number of times sudden deceleration is detected is less than or equal to one, the condition that the number of times sudden steering is detected is less than or equal to one, and the condition that the number of times short-time turn signal operation is detected is less than or equal to two need to be cleared. Level 4 is higher in difficulty level than Level 3 because the threshold of the number of times each item is detected is reduced and the numbers of times other items are detected are also taken into consideration. To select a mission of Level 4 for any one of the items, Level 3 missions for all the items need to be cleared.

When Level 4 and Level 5 are compared in each item, the threshold of the number of times each item is detected is the same, but the mission distance is extended. Therefore, Level 5 is higher in difficulty level than Level 4.

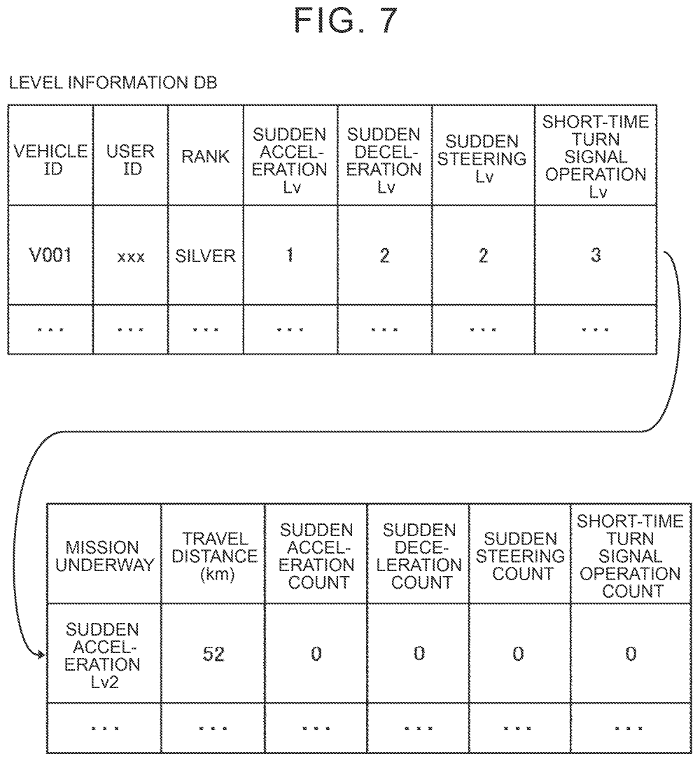

The control unit 31 stores levels of items cleared by the user so far and levels of items underway by the user in the level information DB 35. Here, FIG. 7 is a view that illustrates a table configuration of the level information DB 35 according to the first embodiment. The level information DB 35 has fields of vehicle ID, user ID, rank, sudden acceleration Lv, sudden deceleration Lv, sudden steering Lv, short-time turn signal operation Lv, mission underway, travel distance, sudden acceleration count, sudden deceleration count, sudden steering count, and short-time turn signal operation count. The vehicle ID and the user ID in the level information DB 35 are associated with the vehicle ID and the user ID in the vehicle information DB 33.

Information on the rank of the user is stored in the rank field. The rank of the user is, for example, set according to the number of missions cleared so far. For example, the rank may be raised each time four missions are cleared. The rank, for example, rises in order of Bronze, Silver, Gold, Platinum, and Diamond. The rank of the user may be shown on, for example, an initial screen of the application, a screen indicating the progress of a mission, or the like.

Information on the level cleared in the item of sudden acceleration is input to the sudden acceleration Lv field. Information on the level cleared in the item of sudden deceleration is input to the sudden deceleration Lv field. Information on the level cleared in the item of sudden steering is input to the sudden steering Lv field. Information on the level cleared in the item of short-time turn signal operation is input to the short-time turn signal operation Lv field. Information on a mission currently underway is input to the mission underway field. For example, information on the item and the level underway is input to the mission underway field. When there is no level underway, the mission underway field is blank. Information on the travel distance of the vehicle 10 from when a mission underway is started is input to the travel distance field. The travel distance is, for example, obtained based on information input to the travel distance field of the vehicle information DB 33.

Information on the number of times sudden acceleration is detected from when a mission underway is started is input to the sudden acceleration count field. Information on the number of times sudden deceleration is detected from when a mission underway is started is input to the sudden deceleration count field. Information on the number of times sudden steering is detected from when a mission underway is started is input to the sudden steering count field. Information on the number of times short-time turn signal operation is detected from when a mission underway is started is input to the short-time turn signal operation count field. Pieces of information on the numbers of times of these items are counted by the control unit 31.

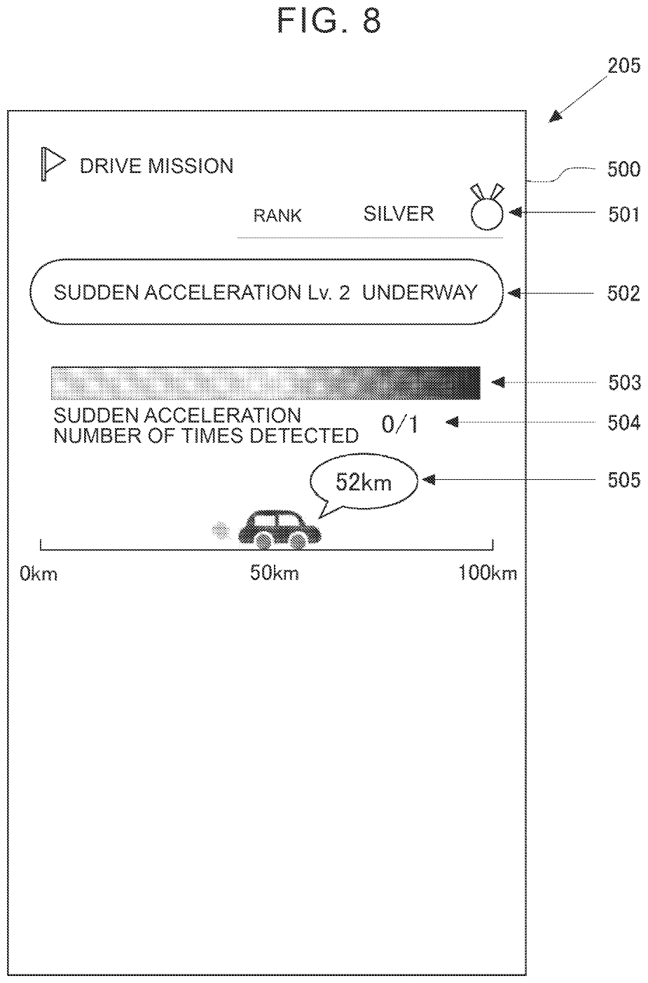

The control unit 31 generates a command to cause the user terminal 20 to show the item and level underway by the user and sends the command to the user terminal 20. FIG. 8 is a view that shows an example of an initial screen 500 that appears as a result of launching the application in the user terminal 20. The initial screen 500 is a screen to be shown initially on the display 205 when the application is launched in the user terminal 20. The rank of the user is shown on the initial screen 500 as indicated by the reference sign 501. In the example shown in FIG. 8, the rank is Silver. The image of a medal with a color corresponding to the rank is shown to the right side of the rank.

A mission currently underway is shown on the initial screen 500 as indicated by the reference sign 502. In the example shown in FIG. 8, a situation in which Level 2 of sudden acceleration is underway is shown. When a plurality of items is underway, one or some of the items may be randomly shown or all of the items may be shown. Furthermore, as indicated by the reference sign 503 and the reference sign 504, the number of times of a behavior detected in the item underway is shown together with the threshold on the initial screen 500. At the portion indicated by the reference sign 503, the number of times sudden acceleration is detected is represented by a bar graph so that the user can understand at a glance. When sudden acceleration is detected, the bar graph shifts leftward, with the result that the user is able to visually determine the situation. The example shown in FIG. 8 indicates that, at the portion indicated by the reference sign 504, the number of times sudden acceleration is detected is zero and the threshold is less than or equal to one. As indicated by the reference sign 505, the travel distance of the vehicle 10 from when the mission is started is shown. In the example shown in FIG. 8, it appears at a glance that the vehicle 10 has travelled 52 km from when the mission is started and the mission distance is 100 km.

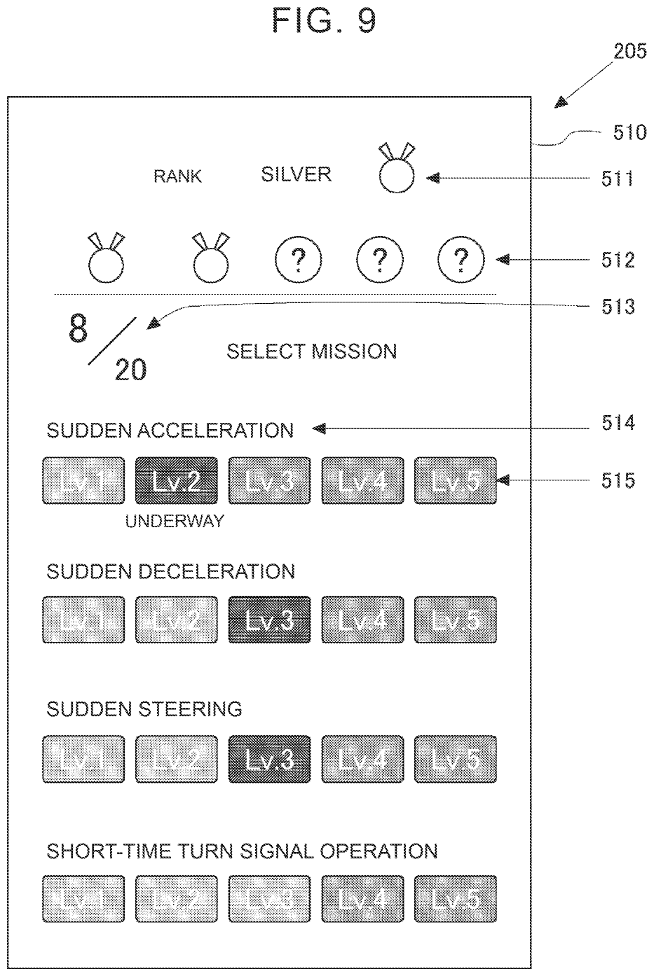

FIG. 9 is a view that shows an example of a screen to select a mission (hereinafter, referred to as select screen 510). When, for example, a portion showing the rank indicated by the reference sign 501 on the initial screen 500 shown in FIG. 8 is tapped, the screen shifts to the select screen 510 shown in FIG. 9. On the select screen 510 as well, the rank of the user is shown as indicated by the reference sign 511. As indicated by the reference sign 512, medals obtained by the user so far are shown. When the rank is Silver, it means that two medals, that is, Bronze and Silver, are obtained. Therefore, two medals are shown at the portion indicated by the reference sign 512. When “?” at the portion indicated by the reference sign 512 is tapped, conditions to obtain the next medal (that is, conditions to rise up to the next rank) may be shown.

As indicated by the reference sign 513, the number of missions cleared (for example, eight) to the total number of missions (for example, 20) is shown on the select screen 510. As indicated by the reference sign 514, an item is shown, and the level currently underway is shown below the item as indicated by the reference sign 515. Cleared levels, levels available to try, and levels unavailable to try are shown by, for example, different colors. The text “Underway” is shown below the level underway. In the example shown in FIG. 9, Level 2 of sudden acceleration is underway, and, other than that, Level 3 of sudden deceleration or Level 3 of sudden steering may be selected.

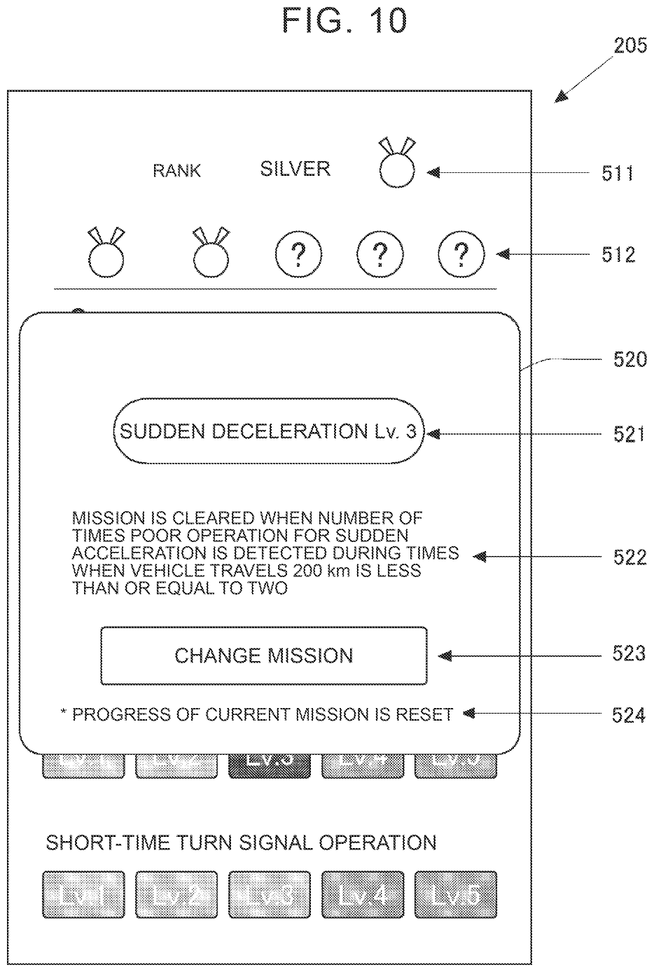

The user is allowed to change a mission to another mission while trying the mission. FIG. 10 is a view that shows a window (hereinafter, referred to as change window 520) that is shown when a button of Level 3 of sudden deceleration in FIG. 9 is tapped. The change window 520 pops up on the select screen 510. As indicated by the reference sign 521, information regarding the item and the level tapped by the user is shown in the change window 520. As indicated by the reference sign 522, a condition to clear the mission is displayed. Furthermore, as indicated by the reference sign 523, a push button to finalize the change of the mission is shown. When the user taps the push button, a request to change the mission is sent from the user terminal 20 to the server 30. When the mission is changed in this way, the progress of the mission underway so far is, for example, reset, so a message prompting the user to pay attention is shown as indicated by the reference sign 524.

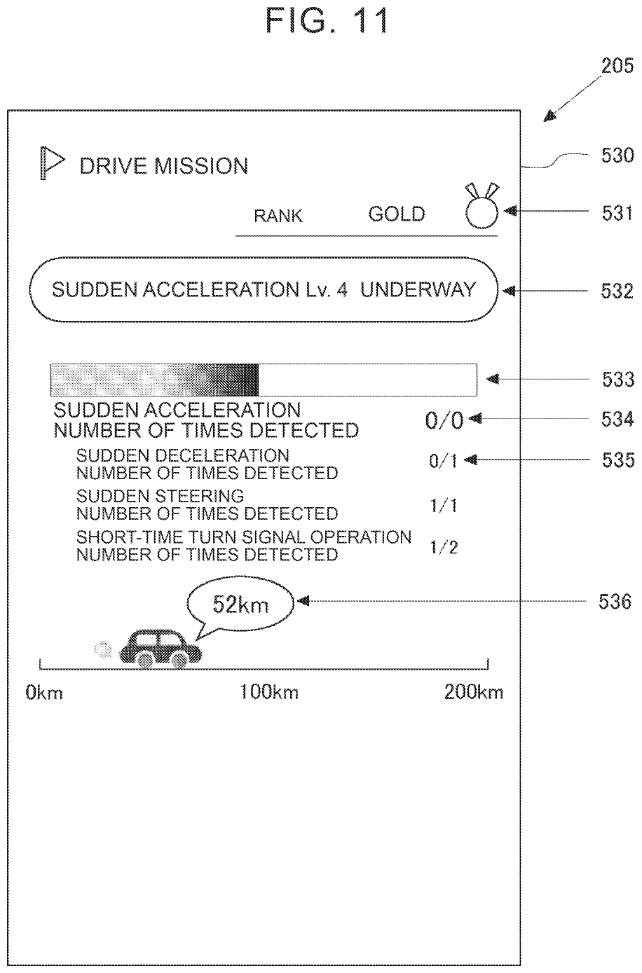

FIG. 11 is a view that shows an example of an initial screen 530 representing that Level 4 of sudden acceleration is underway. The initial screen 530 is a screen to be shown initially on the display 205 when the application is launched in the user terminal 20. The rank of the user is shown on the initial screen 530 as indicated by the reference sign 531. In the example shown in FIG. 11, the rank is Gold. The image of a medal with a color corresponding to the rank is shown to the right side of the rank.

A mission currently underway is shown on the initial screen 530 as indicated by the reference sign 532. In the example shown in FIG. 11, a situation in which Level 4 of sudden acceleration is underway is shown. Furthermore, as indicated by the reference sign 533, the reference sign 534, and the reference sign 535, the number of times of a behavior detected in the item underway is displayed together with the threshold on the initial screen 530. At the portion indicated by the reference sign 533, the number of times each item is detected is represented by a bar graph so that the user can understand at a glance. When each item is detected, the bar graph shifts leftward, with the result that the user is able to visually determine the situation. The example shown in FIG. 11 indicates that, at the portion indicated by the reference sign 534, the number of times sudden acceleration is detected is zero and the threshold is less than or equal to zero. At the portion indicated by the reference sign 535, the number of times sudden deceleration is detected is zero, and the threshold is less than or equal to one. Furthermore, information is similarly shown for sudden steering and short-time turn signal operation. As indicated by the reference sign 536, the travel distance of the vehicle 10 from when the mission is started is shown. In the example shown in FIG. 11, it appears at a glance that the vehicle 10 has travelled 52 km from when the mission is started and the mission distance is 200 km.

When the user clears the mission, the control unit 31 shows the select screen 510 shown in FIG. 9 to present a mission of the next level. Therefore, the user is able to try a new mission, so it is possible to suppress the user getting bored with the application.

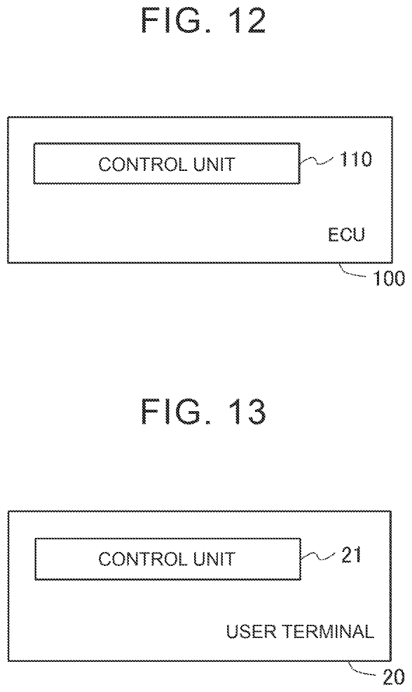

Next, a functional component element of the ECU 100 of the vehicle 10 will be described. FIG. 12 is a diagram that shows an example of a functional component element of the ECU 100 according to the first embodiment. The ECU 100 includes a control unit 110 as a functional component element. The processor 101 of the ECU 100 executes a process of the control unit 110 in accordance with a computer program on the main storage 102. However, any one or some of the functional component elements or part of the process thereof may be executed by a hardware circuit.

The control unit 110 sends information on detected values of the sensor group 41 to the server 30 at intervals of a predetermined period of time or every trip. At this time, the information on the detected values is sent together with information needed for driving assessment, that is, vehicle ID, location information, time information, and the like, as travel information.

Next, the functions of the user terminal 20 will be described. FIG. 13 is a diagram that shows the functional configuration of the user terminal 20 according to the first embodiment. The user terminal 20 includes a control unit 21 as a functional component element. The processor 201 of the user terminal 20 executes a process of the control unit 21 in accordance with a computer program on the main storage 202. However, part of the process of the control unit 21 may be executed by a hardware circuit. An application capable of referencing a level corresponding to the rank of the user and a mission is installed in the user terminal 20, and the control unit 21 runs the application.

The control unit 21 launches the application when the user performs predetermined input to the input unit 204. When, for example, the user taps an icon associated with the application, the control unit 21 launches the application. When the application is launched by the control unit 21, the initial screen 500 shown in FIG. 8 is, for example, displayed. At this time, the control unit 21 accesses the server 30 and makes a request for information needed to show the initial screen 500.

When the user taps the portion where the rank indicated by the reference sign 501 is shown in FIG. 8, the control unit 21 shows the select screen 510. At this time, the control unit 21 accesses the server 30 and makes a request for information needed to show the select screen 510. The control unit 21 displays the select screen 510 based on the information received from the server 30. Thus, it is possible to show the user missions selectable by the user.

When the user taps the portion of the level of the selectable item in FIG. 9, the control unit 21 shows the change window 520 as shown in FIG. 10. When the user taps the push button indicated by the reference sign 523, the control unit 21 sends a request to change the mission to the server 30.

When the mission is cleared, notification may be sent from the server 30 to the user terminal 20. Examples of the notification include push notification, SMS notification, and notification by e-mail. The notification may contain a command to cause the display 205 to show that the mission is cleared. For example, when the mission is cleared while the user is trying the mission of Level 2 for sudden acceleration as shown in FIG. 9, notification that the mission is cleared is provided to the user terminal 20. When the rank has risen at this time, notification that the rank has risen is also provided to the user terminal 20. When the user opens the select screen 510 next time, Level 3 for sudden acceleration is selectable. In this way, when the mission is cleared, a mission with a higher difficulty level is presented to the user.

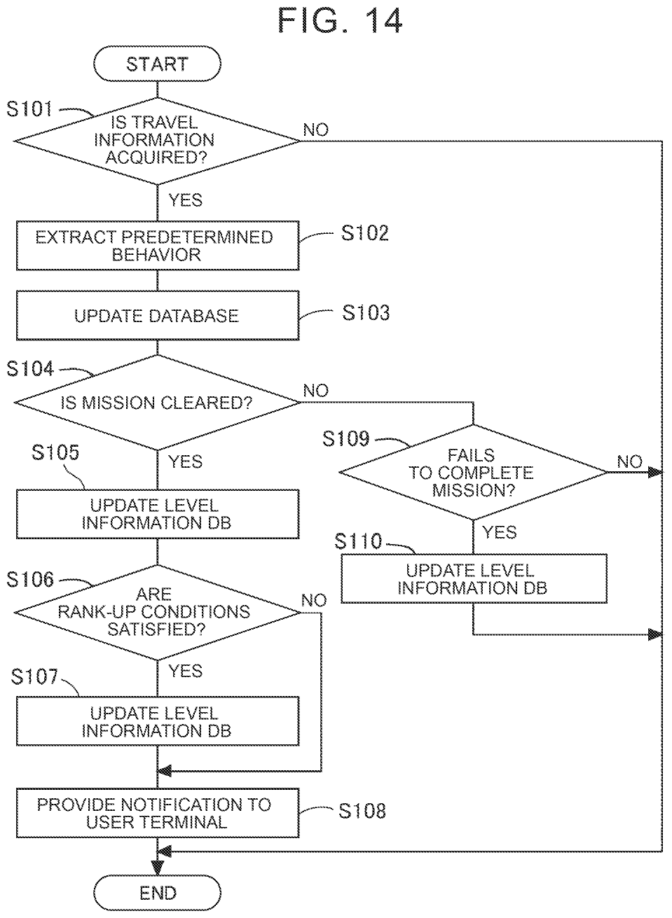

Next, a process of managing missions in the server 30 will be described. FIG. 14 is a flowchart of the process of managing missions in the server 30 according to the first embodiment. The process shown in FIG. 14 is executed in the server 30 every one trip of the vehicle 10.

In step S101, the control unit 31 determines whether travel information has been received from the vehicle 10. Travel information may be, for example, sent from the vehicle 10 at the time of a shutdown (which may be the time when ignition is turned off (IG-OFF)) of the vehicle 10 or sent from the vehicle 10 at intervals of a predetermined period of time. When the determination is affirmative in step S101, the process proceeds to step S102; whereas, when the determination is negative in step S101, the process ends.

In step S102, the control unit 31 extracts a predetermined behavior. The control unit 31 determines whether there is a predetermined behavior based on the detected values of the sensor group 41. In step S103, the control unit 31 updates the vehicle information DB 33 and the detection information DB 34 according to the predetermined behavior. In other words, when there is a predetermined behavior, the control unit 31 adds one to the corresponding record of the vehicle information DB 33 and generates a new record in the detection information DB 34.

In step S104, the control unit 31 determines whether there is a mission cleared. The control unit 31 determines whether conditions to clear the mission currently underway are satisfied by comparing the mission data 36 shown in FIG. 6 with the level information DB 35 shown in FIG. 7. In other words, when the travel distance stored in the travel distance field of the level information DB 35 is longer than or equal to the mission distance of the mission data 36, and the number of times each item is detected, stored in the count field of each item in the level information DB 35, is less than or equal to a corresponding one of the thresholds stored in the mission data 36, the control unit 31 determines that the mission is cleared. When the determination is affirmative in step S104, the process proceeds to step S105; whereas, when the determination is negative in step S104, the process proceeds to step S109.

In step S105, the control unit 31 updates the level information DB 35. The control unit 31 raises the level corresponding to the cleared item by one, among the sudden acceleration Lv field, the sudden deceleration Lv field, the sudden steering Lv field, and the short-time turn signal operation Lv field. The control unit 31 resets the mission underway field, the travel distance field, the sudden acceleration count field, the sudden deceleration count field, the sudden steering count field, and the short-time turn signal operation count field.

In step S106, the control unit 31 determines whether conditions to rank up are satisfied. For example, the rank rises each time four missions are cleared, so the control unit 31 determines whether the conditions to rank up are satisfied based on pieces of information on level, respectively stored in the sudden acceleration Lv field, the sudden deceleration Lv field, the sudden steering Lv field, and the short-time turn signal operation Lv field of the level information DB 35 and information on the rank, stored in the rank field. When the determination is affirmative in step S106, the process proceeds to step S107; whereas, when the determination is negative in step S106, the process proceeds to step S108.

In step S107, the control unit 31 updates the level information DB 35. The control unit 31 stores information on the rank higher in level by one in the rank field. In step S108, the control unit 31 provides notification that the mission is cleared to the user terminal 20. At this time, the control unit 31 may send, to the user terminal 20, a command to cause the display 205 of the user terminal 20 to show the cleared item and level. When the rank goes up, the control unit 31 may send, to the user terminal 20, a command to cause the display 205 of the user terminal 20 to show a new rank.

On the other hand, in step S109, the control unit 31 determines whether the user fails to complete the mission. The control unit 31 determines whether the user fails to complete the mission currently underway by comparing the mission data 36 shown in FIG. 6 with the level information DB 35 shown in FIG. 7. When, for example, the number of times a predetermined behavior is detected exceeds the threshold stored in the mission data 36 shown in FIG. 6, the control unit 31 determines that the user fails to complete the mission. When the determination is affirmative in step S109, the process proceeds to step S110; whereas, when the determination is negative in step S109, the process ends.

In step S110, the control unit 31 resets the travel distance field, the sudden acceleration count field, the sudden deceleration count field, the sudden steering count field, and the short-time turn signal operation count field. Thus, the user retries the mission input to the mission underway field from the beginning.

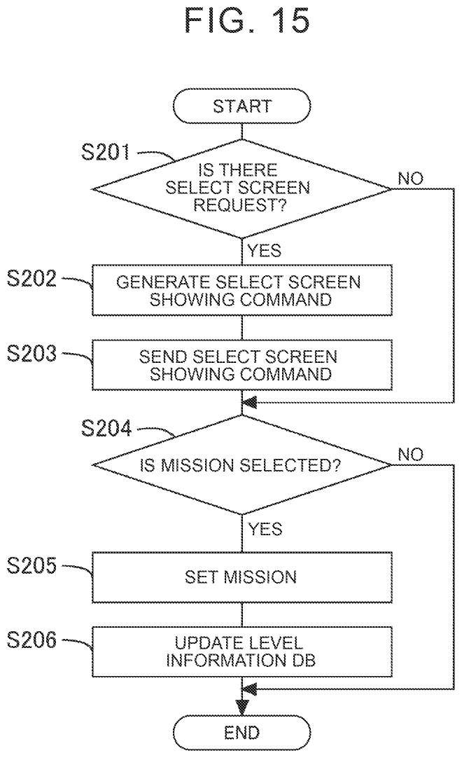

Next, a process of presenting missions in the server 30 will be described. FIG. 15 is a flowchart of the process of presenting missions in the server 30 according to the first embodiment. The process shown in FIG. 15 is executed in the server 30 at intervals of a predetermined period of time. In step S201, the control unit 31 determines whether a select screen request has been received from the user terminal 20. The select screen request is, for example, a request to show the select screen 510 shown in FIG. 9. The select screen request is generated by the control unit 21 of the user terminal 20 when the user taps the portion where the rank is shown on the initial screen 500, and the control unit 21 sends the select screen request to the server 30. When the determination is affirmative in step S201, the process proceeds to step S202; whereas, when the determination is negative in step S201, the process proceeds to step S204.

In step S202, the control unit 31 generates a select screen showing command. The select screen showing command is a command to cause the display 205 of the user terminal 20 to show the select screen 510. The control unit 31 extracts the missions cleared and the mission underway based on the level information DB 35 shown in FIG. 7. The control unit 31 also extracts selectable missions. The control unit 31 generates a select screen showing command based on these pieces of information. In step S203, the control unit 31 sends the select screen showing command generated to the user terminal 20. Thus, the control unit 31 presents selectable missions to the user.

In step S204, the control unit 31 determines whether a mission is selected in the user terminal 20. When a mission is selected in the user terminal 20, information on the mission selected is sent from the user terminal 20 to the server 30. When the determination is affirmative in step S204, the process proceeds to step S205; whereas, when the determination is negative in step S204, the process ends.

In step S205, the control unit 31 sets the mission. The control unit 31 sets the mission acquired in step S204 as a mission to be tried by the user. In step S206, the control unit 31 inputs the mission selected by the user to the mission underway field of the level information DB 35.

As described above, according to the present embodiment, it is possible to set a mission for a user and determine whether the mission is cleared based on driving assessment. When the user clears the mission, a plurality of missions including a mission with a higher difficulty level is presented to the user, so it is possible to suppress the user getting bored with the application. The user also tries to perform safe driving to clear the mission.

### Second Embodiment

In the first embodiment, only a mission for one of a plurality of items is allowed to be selected; whereas, in a second embodiment, a mission or missions for one or more items are allowed to be selected. However, missions of the same details are disabled to be selected at the same time. For example, in FIG. 6, the user is allowed to select a plurality of items from Level 1 to Level 3. In other words, a mission or missions are set in one or multiple items among sudden acceleration, sudden deceleration, sudden steering, and short-time turn signal operation. On the other hand, in Level 4 and Level 5, the details of the missions partially overlap among the items. Therefore, in Level 4 and Level 5, if missions for a plurality of items are set at the same time, there is a possibility that all the missions may be cleared at the same time. For this reason, for example, only one item may be selectable in Level 4 and Level 5. In another method, one or more items may be selectable even in Level 4 and Level 5.

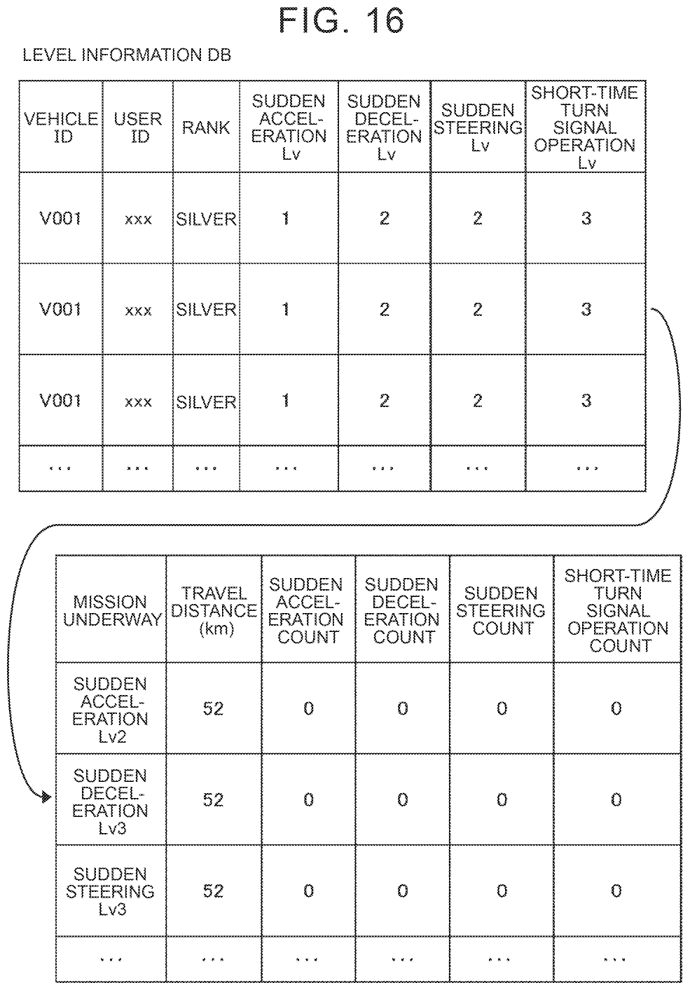

FIG. 16 is a view that illustrates a table configuration of the level information DB 35 according to the second embodiment. The level information DB 35 has fields of vehicle ID, user ID, rank, sudden acceleration Lv, sudden deceleration Lv, sudden steering Lv, short-time turn signal operation Lv, mission underway, travel distance, sudden acceleration count, sudden deceleration count, sudden steering count, and short-time turn signal operation count. Different from the table configuration of the level information DB 35 shown in FIG. 7, records corresponding to the items underway are generated. FIG. 16 illustrates the table configuration of the level information DB 35 in a case where Level 2 for sudden acceleration, Level 3 for sudden deceleration, and Level 3 for sudden steering are set as missions. When, for example, sudden steering is detected three times, the user fails to complete the mission for sudden steering, so values in the fields of travel distance, sudden acceleration count, sudden deceleration count, sudden steering count, and short-time turn signal operation count in the record corresponding to sudden steering are reset.

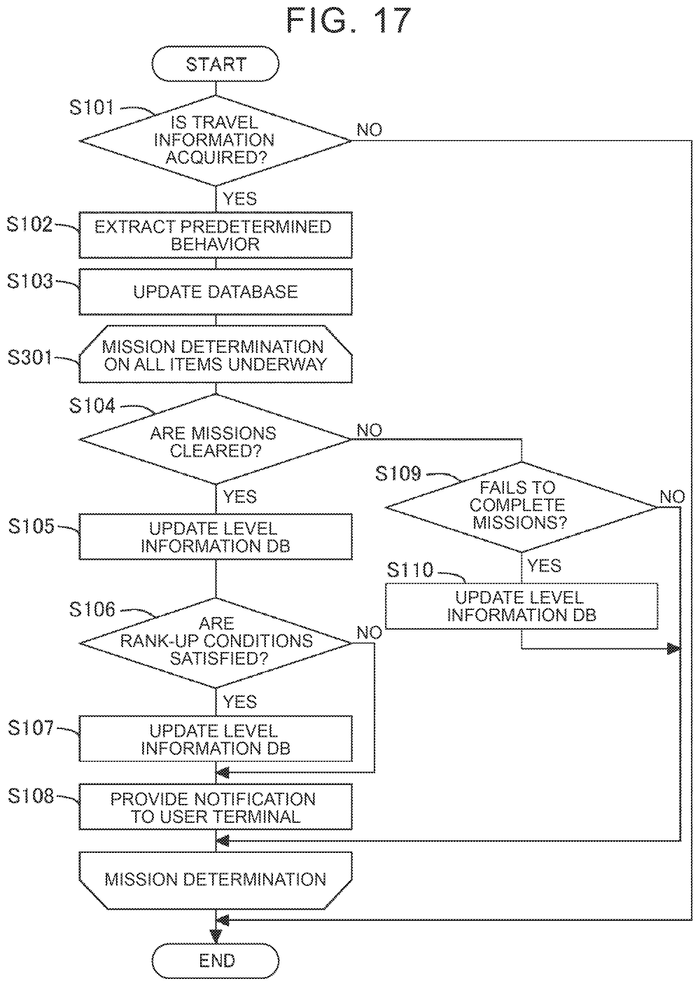

FIG. 17 is a flowchart of a process of managing missions in the server 30 according to the second embodiment. The process shown in FIG. 17 is executed in the server 30 every one trip of the vehicle 10. Like step numbers are assigned to steps in which the same processes as those of the routine shown in FIG. 14 are executed, and the description thereof is omitted. In the routine shown in FIG. 17, the control unit 31 repeatedly executes the processes from step S104 to step S110 for the items underway (see step S301). At this time, the control unit 31 executes processes corresponding to all the missions input in the mission underway field of FIG. 16.

Next, a process of presenting missions in the server 30 will be described with reference to FIG. 15. The control unit 31 generates a select screen showing command in step S202 of the routine shown in FIG. 15. The control unit 31 extracts the missions cleared and the missions underway based on the level information DB 35 shown in FIG. 7. The control unit 31 also extracts selectable missions. At this time, when a plurality of missions is selectable, the control unit 31 extracts a plurality of missions. The control unit 31, for example, extracts a selectable mission for each item. Thus, an upper limit is set for the number of missions to be set. The control unit 31 generates a select screen showing command based on these pieces of information. In step S203, the control unit 31 sends the select screen showing command generated to the user terminal 20. Thus, the control unit 31 may present a plurality of selectable missions to the user.

In step S204, the control unit 31 determines whether a mission is selected in the user terminal 20. When a mission is selected in the user terminal 20, information on the mission selected is sent from the user terminal 20 to the server 30. At this time, a plurality of missions can be selected. When the determination is affirmative in step S204, the process proceeds to step S205; whereas, when the determination is negative in step S204, the process ends.

In step S205, the control unit 31 sets the mission. The control unit 31 sets the mission acquired in step S204 as a mission to be tried by the user. At this time, a plurality of missions can be set. In step S206, the control unit 31 inputs the mission selected by the user to the mission underway field of the level information DB 35.

As described above, according to the present embodiment, it is possible to set a plurality of missions for a user and determine whether the missions are cleared based on driving assessment. When the user clears the missions, a plurality of missions including a mission with a higher difficulty level is presented to the user, so it is possible to suppress the user getting bored with the application. The user also tries to perform safe driving to clear the missions.

### Third Embodiment

In a third embodiment, a user is given an incentive according to a mission cleared. When, for example, a mission is cleared, a predetermined amount of money may be transferred or points are added on the application. The points may be available in, for example, payment of an automobile insurance, purchase of a vehicle, payment of a toll of a toll road, or the like. The incentive may be increased according to the level of a mission cleared.

Here, for example, in automobile leasing, a leasing company pays an automobile insurance fee. Therefore, if an accident occurs, an insurance fee that the leasing company pays increases. In contrast, when an incentive is given to the user based on the result of a mission, the user keeps in mind to perform safe driving, so it is possible to reduce accidents. When an incentive is given to only the user of the application, it is possible to increase the user of the application.

On the other hand, funds may be limited to give an incentive. In the third embodiment, a cap (upper limit) is put on an incentive, and an incentive is effectively given within the funds. A cap is, for example, put every trip, every day, every week, every month, or every year.

For example, it is assumed that an upper limit of an annual incentive per person is set to 5000 points, an upper limit of a monthly incentive is set to 200 points (annually 2400 points), and a campaign incentive is set to 800 points. In this case, 5000−2400−800=1800 points remain, so an incentive per day is given from the 1800 points. Then, at the time when a total amount of incentives given per day reaches 1800 points, giving an incentive is stopped.

This 1800 points may be set on a year basis. In other words, when a total amount of incentives given per day in a year reaches 1800 points, it may be possible not to give an incentive per day in that year from then on. It may also be set on a monthly basis. For example, an upper limit of an incentive per month may be set to 1800/12=150 points. In other words, when a total amount of incentive given per day in a month reaches 150 points, it may be possible not to give an incentive per day in that month from then on. When the incentive reaches an upper limit, for example, a message like “MAX Points Achieved!” may be displayed on the initial screen 500. Thus, it is possible to give a sense of accomplishment to the user.

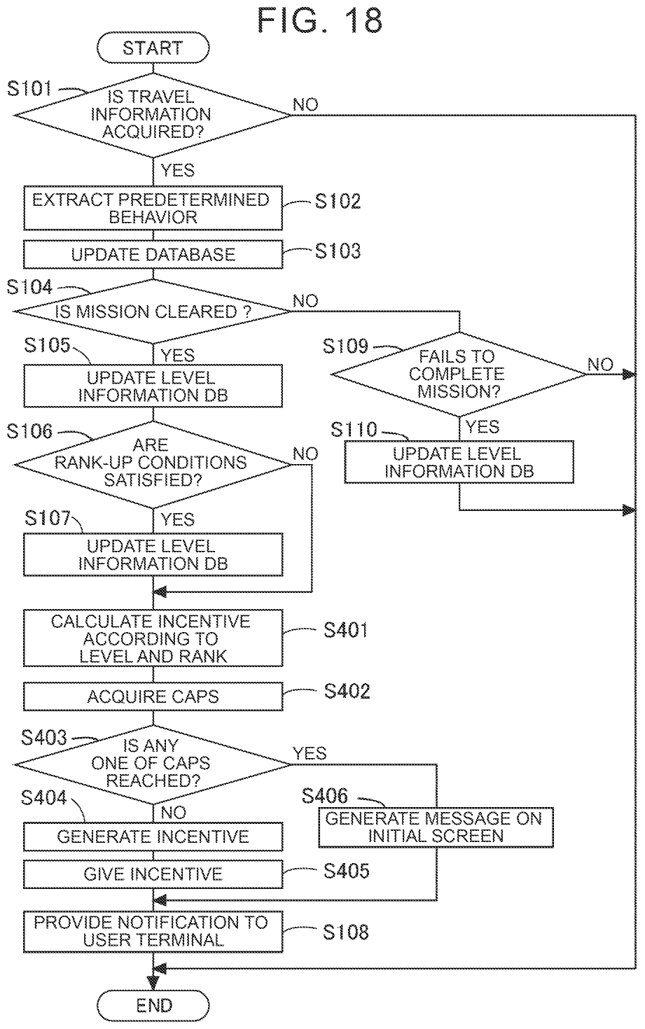

FIG. 18 is a flowchart of a process of giving an incentive in the server 30 according to the third embodiment. Like step numbers are assigned to steps in which the same processes as those of the routine shown in FIG. 14 are executed, and the description thereof is omitted.

In the flowchart shown in FIG. 18, when the determination is negative in step S106 or when the process of step S107 ends, the process proceeds to step S401. In step S401, the control unit 31 calculates an incentive based on the level of the mission cleared. At this time, for example, an incentive is calculated such that the incentive increases as the level cleared rises. In another method, an incentive may be a fixed value. When all the missions in the same level are cleared, an incentive may be added as a bonus. Furthermore, when the rank goes up, an incentive may be added as a bonus. At this time, an incentive may be increased as the rank rises. In a case where a plurality of missions is underway, when the missions are cleared at the same time, an incentive may be added as a bonus in addition to an incentive for each mission.

In step S402, the control unit 31 acquires the caps put on incentives. For example, a daily cap, a weekly cap, a monthly cap, an annual cap, and the like are put, and these caps are stored in the auxiliary storage 303. In step S403, the control unit 31 determines whether the incentives given till then have reached any one of the caps. The control unit 31, for example, determines whether the incentives have reached any one of the caps by comparing the incentives given till then with each of the daily cap, the weekly cap, the monthly cap, and the annual cap. The incentives given till then are, for example, stored in the auxiliary storage 303 together with date information. When the determination is affirmative in step S403, the process proceeds to step S406; whereas, when the determination is negative in step S403, the process proceeds to step S404.

In step S404, the control unit 31 generates an incentive. At this time, an incentive is generated such that the incentive calculated in step S401 is given to the user. In step S405, the control unit 31 gives the incentive to the user. Information on incentives is, for example, sent to the user terminal 20 and stored in the auxiliary storage 203 of the user terminal 20. The control unit 31 may provide notification to the user terminal 20 in step S108 such that a message informing that the incentive is given is shown on the initial screen 500.

On the other hand, in step S406, the control unit 31 generates a message on the initial screen 500 such that information indicating that the incentives have reached the upper limit is shown on the initial screen 500.

As described above, according to the present embodiment, since an incentive is given to the user when the user clears a mission, the user keeps in mind for safe driving, so it is possible to reduce accidents. An incentive is not given until the application is installed, so it is possible to facilitate installation of the application. It is also possible to suppress the user getting bored with the application.

### Fourth Embodiment

In a fourth embodiment, a plurality of categories will be described. In the first embodiment, items on safe driving, such as sudden acceleration, sudden deceleration, sudden steering, and short-time turn signal operation, are targeted by missions; however, items other than these can be targeted by missions. For example, it is possible to set a mission for driving that reduces a CO₂ emission amount or driving that improves fuel efficiency. For example, missions corresponding to driving on ecology (hereinafter, also referred to as eco-driving) may be set independently of missions on safe driving. Examples of items of missions on eco-driving include moderate start, moderate acceleration, traveling with a constant accelerator operation amount (steady traveling), use of regenerative brake, and stop-start function.

Moderate start is an item on acceleration when the vehicle 10 starts traveling from a stopped state (that is, at the time of start). Moderate acceleration is an item on acceleration other than at the time of start of the vehicle 10. For moderate start and moderate acceleration, as in the case of the item of sudden acceleration, a mission may be set with an amount of change in the speed of the vehicle 10 as a threshold. When, for example, the number of times sudden acceleration is detected during times when the vehicle 10 travels 100 km is less than or equal to three, it may be determined that a mission of Level 1 for moderate acceleration is cleared.

Steady traveling is an item on the fact that the vehicle 10 travels in a steady state. For the item of steady traveling, as in the case of the items of sudden acceleration and sudden deceleration, a mission may be set with a change in the speed of the vehicle 10 as a threshold. When, for example, the number of times sudden acceleration is detected during times when the vehicle 10 travels 100 km is less than or equal to three and the number of times sudden deceleration is detected during times when the vehicle 10 travels 100 km is less than or equal to five, it may be determined that a mission of Level 1 for steady traveling is cleared.

Use of regenerative brake is an item on the fact that the vehicle 10 uses regenerative brake. For example, electric power cannot be recovered through regenerative brake if sudden braking is performed, so a mission is set such that sudden braking is not performed. For use of regenerative brake, for example, as in the case of sudden deceleration, a mission may be set with a change in the speed of the vehicle 10 as a threshold.

Stop-start function is an item on the fact that an engine stops during a stop of the vehicle 10. For stop-start function, for example, a mission may be set by setting a threshold to a period of time during which the engine is in operation when the vehicle speed is 0 km/h.

Items corresponding to driving on improvement in driving technique (hereinafter, also referred to as skill driving) may be targeted by missions. Examples of missions on skill driving include slowly starting to turn and return during steering operation and moderate cornering. Slowly starting to turn and return during steering operation is set as a mission on a steering angle when steering operation is started. Moderate cornering is set as a mission on steering angle during steering operation. For example, a threshold may be set to a change in steering angle per unit time, and a mission may be set based on the number of times the threshold is exceeded.

The control unit 31 may set one mission for each of safe driving, eco-driving, and skill driving. In another method, the control unit 31 may set one or more missions for each of safe driving, eco-driving, and skill driving. Furthermore, in another method, the control unit 31 may set a mission to only any one of safe driving, eco-driving, and skill driving.

The control unit 31 may be configured to, for example, disable setting of missions with similar details. For example, missions of which criteria overlap can be cleared at the same time, so such missions may be disabled from being set at the same time. When, for example, a mission for sudden acceleration of safe driving is set, a mission for moderate acceleration of eco-driving may be disabled from being set. Missions that can be set at the same time and missions that cannot be set at the same time are stored in the auxiliary storage 303.

It may be predicated that a plurality of missions is combined. For example, it may be indispensable to set one mission for each of safe driving, eco-driving, and skill driving. The number of missions to be set may be limited in correspondence with each category. For example, only one mission may be set for each of safe driving, eco-driving, and skill driving. When the control unit 31 gives an incentive at the time when a mission is cleared, the control unit 31 may for example, add an incentive as a bonus to an incentive for each item when a plurality of missions for safe driving, eco-driving, and skill driving is cleared at the same time. For example, as in the case of the routine shown in FIG. 17, the control unit 31 determines whether missions for all the items underway are cleared.

As described above, according to the present embodiment, a plurality of missions of different categories may be set, so the user is able to use the application in an enjoyable format.

### Other Embodiments

The above-described embodiments are only illustrative, and the disclosure can be implemented with modifications as needed without departing from the purport of the disclosure. The processes and devices described in this disclosure may be freely implemented in combination without any technical contradiction. A process described as the one that is performed by a device may be shared and performed by multiple devices. Alternatively, processes described as the ones that are respectively performed by different devices may be performed by a device. In a computer system, what hardware configuration (server configuration) implements functions may be flexibly changed. For example, part or all of the functions of the server 30 may be provided in the vehicle 10.

The disclosure may also be implemented as follows. A computer is supplied with a computer program having the functions described in the above-described embodiments, and one or more processors of the computer read out and run the program. Such a computer program may be provided to a computer with a non-transitory computer-readable storage medium connectable to a system bus of the computer or may be provided to a computer via a network. Examples of the non-transitory computer-readable storage medium include a disk or disc of any type, such as a magnetic disk (floppy (registered trademark) disk, a hard disk drive (HDD), or the like), an optical disc (CD-ROM, DVD disc, a Blue-ray disc, or the like), a read only memory (ROM), a random access memory (RAM), an EPROM, an EEPROM, a magnetic card, a flash memory, an optical card, and a medium of any type suitable for storing electronic instructions.

What is claimed is:

1. An information processing apparatus comprising a control unit configured to execute:
a process of presenting a user a plurality of missions respectively corresponding to a plurality of items of driving assessment;
a process of setting one or more first missions for the user, the one or more first missions being selected by the user from among the plurality of missions;
a process of determining whether the user has cleared the one or more first missions based on the driving assessment corresponding to the one or more first missions; and
a process of presenting the user the plurality of missions including a second mission higher in difficulty level than the one or more first missions in response to a situation that the user has cleared the one or more first missions.

2. The information processing apparatus according to claim 1, wherein the control unit is configured to execute a process of determining whether the user has cleared the one or more first missions at intervals of a predetermined travel distance.

3. The information processing apparatus according to claim 1, wherein the control unit is configured to execute a process of setting a rank of the user according to the number of the one or more first missions cleared by the user and presenting the user the rank.

4. The information processing apparatus according to claim 1, wherein the control unit is configured to execute a process of setting a plurality of the first missions for the user in response to a situation that the user has selected the plurality of the first missions.

5. The information processing apparatus according to claim 4, wherein the control unit is configured to execute a process of setting the first mission for the user for each of the plurality of items of driving assessment.

6. The information processing apparatus according to claim 4, wherein the control unit is configured to execute a process of setting an upper limit to the number of the first missions set.

7. The information processing apparatus according to claim 4, wherein the control unit is configured to execute a process of setting limitations on a combination of the plurality of the first missions.

8. The information processing apparatus according to claim 4, wherein the control unit is configured to execute a process of, when the plurality of the first missions is classified into a plurality of categories, setting an upper limit to the number of the first missions corresponding to each of the categories.

9. The information processing apparatus according to claim 1, wherein the control unit is configured to execute a process of, only when all the first missions of the same level among the plurality of missions respectively corresponding to the plurality of items of driving assessment have been cleared, presenting the user the second mission.

10. The information processing apparatus according to claim 1, wherein the control unit is configured to execute a process of notifying the user that the one or more first missions have been cleared in response to a situation that the user has cleared the one or more first missions.

11. The information processing apparatus according to claim 1, wherein the control unit is configured to execute a process of showing the one or more first missions underway by the user on an initial screen of a user interface presenting the plurality of missions.

12. The information processing apparatus according to claim 1, wherein the control unit is configured to execute:
a process of generating information on an incentive according to a situation that the user has cleared the one or more first missions; and
a process of putting a cap on the incentive for every predetermined period.

13. The information processing apparatus according to claim 12, wherein the control unit is configured to execute a process of, when a plurality of the first missions has been cleared at the same time, giving the incentive larger in amount than when one of the one or more first missions has been cleared.

14. An information processing method executed by a computer, the information processing method comprising:
presenting a user a plurality of missions respectively corresponding to a plurality of items of driving assessment;
setting one or more first missions for the user, the one or more first missions being selected by the user from among the plurality of missions;
determining whether the user has cleared the one or more first missions based on the driving assessment corresponding to the one or more first missions; and
presenting the user the plurality of missions including a second mission higher in difficulty level than the one or more first missions in response to a situation that the user has cleared the one or more first missions.

15. The information processing method according to claim 14, further comprising determining whether the user has cleared the one or more first missions at intervals of a predetermined travel distance.

16. The information processing method according to claim 14, further comprising setting a rank of the user according to the number of the one or more first missions cleared by the user and presenting the user the rank.

17. The information processing method according to claim 14, further comprising setting a plurality of the first missions for the user in response to a situation that the user has selected the plurality of the first missions.

18. The information processing method according to claim 14, further comprising, only when all the first missions of the same level among the plurality of missions respectively corresponding to the plurality of items of driving assessment have been cleared, presenting the user the second mission.

19. The information processing method according to claim 14, further comprising notifying the user that the one or more first missions have been cleared in response to a situation that the user has cleared the one or more first missions.

20. The information processing method according to claim 14, further comprising:
generating information on an incentive according to a situation that the user has cleared the one or more first missions; and
putting a cap on the incentive for every predetermined period.
